(19) United States
(12) Patent Application Publication
(10) Pub. No.: US 2024/0381858 A1
(43) Pub. Date: Nov. 21, 2024

(54) FISHHOOK HAVING AN EXTRA BEND FOR SETTING BAIT TO STAY STRAIGHT AND LOOK MORE NATURAL

(71) Applicant: Brian Knighten, Odessa, TX (US)

(72) Inventor: Brian Knighten, Odessa, TX (US)

(21) Appl. No.: 18/617,542

(22) Filed: Mar. 26, 2024

Related U.S. Application Data
(60) Provisional application No. 63/467,728, filed on May 19, 2023.

(51) Int. Cl. A01K 83/06

(52) U.S. Cl. CPC A01K 83/064

(57) ABSTRACT

A fishhook is disclosed. The fishhook includes an eye and a shank connected by an offset section. The fishhook includes a bend extending from the shank. The fishhook includes a hook point extending from the bend. The fishhook includes a barb. The offset section is angled to allow the bait to stay straight and look more natural. The offset section presents a bend/angled portion for opening up the gap between the hook point and the fishing line for better hook ups. The offset section's downward bend allows a jig head to come through the lips of the fish. Further, the bottom of the bend allows pushing the hook point upwards for great hook penetration. In one embodiment, the fishhook includes a fishing lure to lure the fish towards the fishhook.

### REFERENCE TO RELATED APPLICATIONS

The present application claims the benefit of U.S. Provisional Application No. 63/467,728 filed May 19, 2023; all of which is incorporated herein by its entirety and referenced thereto.

### FIELD OF THE INVENTION

The present invention generally relates to fishhooks. More particularly, the present invention relates to a fishhook having an extra bend to allow the bait to stay straight and look more natural.

### DESCRIPTION OF THE RELATED ART

It is known that fishhooks are used by fishermen to catch fish in water. The fishhooks catch the fish by piercing and embedding onto the inside of the fish mouth (angling). Sometimes, the fishhooks catch the fish by impaling and snagging the external body of the fish. The fishhooks come in different shapes, designs and materials depending on the need.

Several fishhooks have been disclosed in the past. One such example is disclosed in a United States Granted U.S. Pat. No. 9,743,648, entitled “Barbless safety fishhook” (“the '648 Patent”). The '648 Patent discloses a barbless safety fishhook that is designed to keep a fish on the fishhook without the use of a barb. The barbless safety fishhook uses constant tension maintained on the fishing line to move the captured fish to a V shaped valley where the fish is secured. In addition, the barbless safety fishhook is fitted with three rubber brakes that prevent the fish from sliding towards the fishhook tip after capture. The barbless safety fishhook comprises a hook and a spring lock.

Another example is disclosed in a United States Publication No. 20130239459, entitled “Fishhook” (“the '459 Publication”). The '459 Publication discloses an improved fishhook having a barb placed between the lower bend and the vertical climb of the shank. The positioning of the barb is strategically positioned a distance from the sharpened point thereby incurring the advantages of a barbless fishhook in combination with the advantages of a barbed fishhook.

Still, there is a need in the art to provide an improved fishhook to catch the fish.

### SUMMARY

It is one of the main objects of the present invention to provide a fishhook and that avoids the drawbacks of the prior art.

It is another object of the present invention to provide a fishhook having an extra bend to allow the bait to stay straight and look more natural.

In order to overcome the limitations here stated, the present invention provides a fishhook. The fishhook includes an eye and a shank connected by an offset section. The fishhook includes a bend extending from the shank. The fishhook includes a hook point extending from the bend. The fishhook includes a barb. The bend is curved or angled to provide a substantially V-shaped bend/configuration. The offset section provides an extra bend (offset section is angled approximately 120 or 150 degrees) that allows the bait to stay straight and look more natural instead of holding the bait horizontally/sideways as in the prior art. The offset section presents a bend/angled portion for opening up the gap between the hook point and the fishing line for better hook ups. The offset section's downward bend on the hook allows a jig head to come through the lips of the fish. Further, the bottom (centre) of the bend allows pushing the hook point upwards for great hook penetration.

In one aspect of the present invention, the fishhook includes a head having an eye for receiving a fishing line. Further, the head includes a fishing lure. Here, the fishhook is casted into the water to lure a fish towards the fishing lure. When the fish catches the fishing lure, a user pulls up the fishing line connected to the fishhook holding the fish.

In one advantageous feature of the present invention, the fishhook provides an extra wide gap due to the shape of the bend and the offset section. With the offset section bent at 120 or 150 degrees with respect to the shank allows the jig head to come through the lips of the fish. Further, the bottom of the bend allows pushing the hook point upwards for great hook penetration.

In another advantageous feature of the present invention, the fishhook includes a fishing lure for luring a fish towards the fishing lure. This helps a user to lure and catch the fish easily.

Features and advantages of the invention hereof will become more apparent in light of the following detailed description of selected embodiments, as illustrated in the accompanying FIGUREs. As will be realized, the invention disclosed is capable of modifications in various respects, all without departing from the scope of the invention. Accordingly, the drawings and the description are to be regarded as illustrative in nature.

### BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 illustrates an environment in which a fishhook implements, in accordance with one embodiment of the present invention;

FIG. 2 and FIG. 3 illustrate a fishhook, in accordance with one embodiment of the present invention;

FIG. 4 and FIG. 5 illustrate a fishhook, in accordance with one embodiment of the present invention;

FIG. 6 and FIG. 7 illustrate a fishhook, in accordance with one embodiment of the present invention;

FIG. 8, FIG. 9 and FIG. 10 illustrate a fishhook apparatus, in accordance with one embodiment of the present invention; and

FIG. 11, FIG. 12, FIG. 13 and FIG. 14 illustrate catching a fish using the fishhook apparatus, in accordance with one embodiment of the present invention.

### DESCRIPTION OF THE EMBODIMENTS OF THE INVENTION

The following detailed description set forth below in connection with the appended drawings is intended as a description of exemplary embodiments in which the presently disclosed invention may be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed fishhook. However, it will be apparent to those skilled in the art that the presently disclosed invention may be practiced without these specific details. In some instances, well-known structures and devices are shown in functional or conceptual diagram form in order to avoid obscuring the concepts of the presently disclosed fishhook.

In the present specification, an embodiment showing a singular component should not be considered limiting. Rather, the invention preferably encompasses other embodiments including a plurality of the same component, and vice-versa, unless explicitly stated otherwise herein. Moreover, the applicant does not intend for any term in the specification to be ascribed an uncommon or special meaning unless explicitly set forth as such. Further, the present invention encompasses present and future known equivalents to the known components referred to herein by way of illustration.

Although the present invention provides a description of a fishhook, it is to be further understood that numerous changes may arise in the details of the embodiments of the fishhook. It is contemplated that all such changes and additional embodiments are within the spirit and true scope of this disclosure.

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure.

The present invention discloses a fishhook. The fishhook includes an eye and a shank connected by an offset section. The fishhook includes a bend extending from the shank. The fishhook includes a hook point extending from the bend. The fishhook includes a barb. The offset section is angled to allow the bait to stay straight and look more natural. The offset section presents a bend/angled portion for opening up the gap between the hook point and the fishing line for better hook ups. The offset section's downward bend allows a jig head to come through the lips of the fish. Further, the bottom of the bend allows pushing the hook point upwards for great hook penetration.

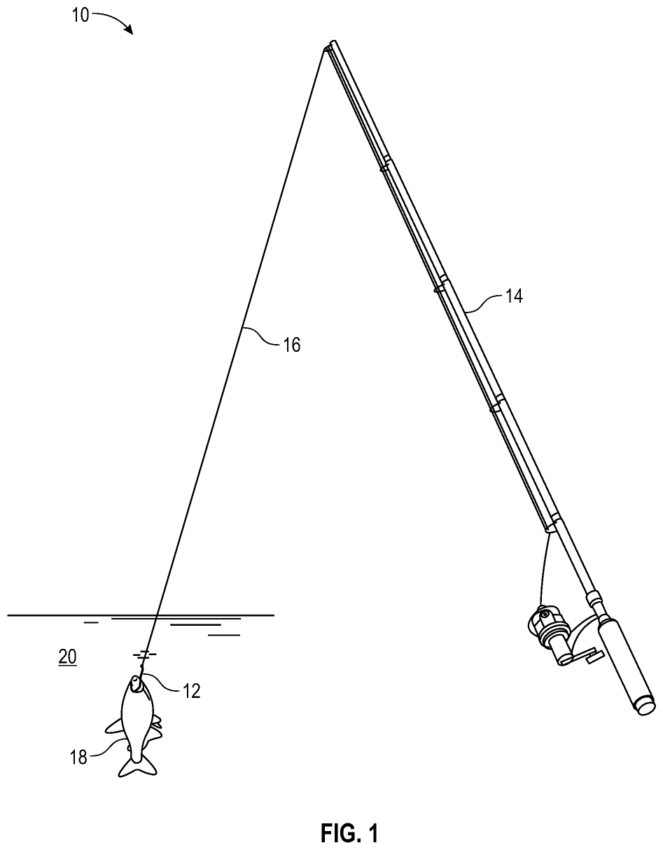

Various features and embodiments of a fishhook are explained in conjunction with the description of FIGURES (FIGS. 1-14.

Referring to FIG. 1, an environment 10 in which a fishhook 12 implements is shown, in accordance with one exemplary embodiment of the present invention. Fishhook 12 connects to a fishing rod 14 via a fishing line 16. Fishhook 12 helps to catch fish 18 in water 20. A user (not shown) casts fishing line 16 into water 20 for luring fish 18 to a bait (not shown) connected to fishhook 12.

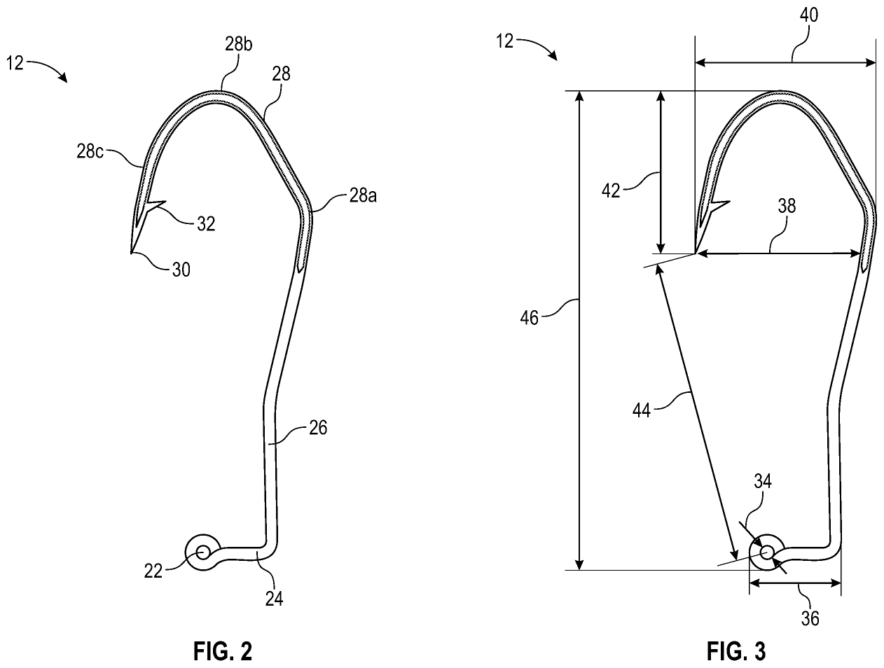

FIG. 2 and FIG. 3 show fishhook 12, in accordance with one embodiment of the present invention. Fishhook 12 includes an eye or hook eye 22. Eye 22 is ringed, brazed, needled, tapered or looped. Eye 22 forms at one end of fishhook 12 and engages fishing line 16. Eye 22 presents an offset section 24. Offset section 24 indicates a portion extended from eye 22 and connecting a shank 26. In the present embodiment, offset section 24 positions at about 90 degrees with respect to shank 26. Fishhook 12 includes a bend or bend section 28 that extends from shank 24. Bend 28 includes a first segment 28a, a second segment 28b, and a third segment 28c. First segment 28a indicates a point at which bend 28 begins. First segment 28a turns towards the center of bend 28. Second segment 28b indicates a centre or bottom of bend 28. Third segment 28c indicates a point at which bend 28 turns inwards. Fishhook 12 includes a hook point or tip 30 at the distal end. Hook point 30 comes in a variety of shapes including, but not limited to, a needle point, a spear point, rolled in point, a hollow point, a knife edge point, etc. As can be seen, bend 28 curves fishhook 12 through approximately 180 degrees so that hook point 30 points in the direction of fishing line 16. Fishhook 12 includes a barb 32. Barb 32 positions adjacent to hook point 30 facing shank 24. Barb 32 provides resistance when fishhook 12 is pulled out upon catching fish 18. In other words, barb 32 indicates a spike extending from the surface of third segment 28c (substantially perpendicular to hook point 30) configured to grab the tissue of fish 18 and stop fishhook 12 from sliding back out of penetration.

Eye 22 has a suitable diameter 34 for receiving fishing line 16, as shown FIG. 3. Offset section 24 has a suitable length from eye 22 (offset length 36). Hook point 30 and shank 24 position at a distance i.e., gap or gape 38. The distance between the outer surface of shank 24 and hook point 30 is designated as numeral 40. The distance from bend 28 to hook point 30 is a front length 42. The distance from eye 22 and hook point 30 is a leverage or leverage gap 44. The distance from eye 22 to bend 28 is referred to as a total length 46.

In accordance with the present invention, bend 28 having first segment 28a, second segment 28b, and third segment 28c presents an extra wide gap (extra bend) between hook point 30 and shank 24. Here, eye 22 positions at a relatively centre of bend 28 and provides the gap between hook point 30 and the fishing line for better hook ups. Offset section 26 allows a bait to stay straight and look more natural. This helps to lure fish 18 into fishhook 12.

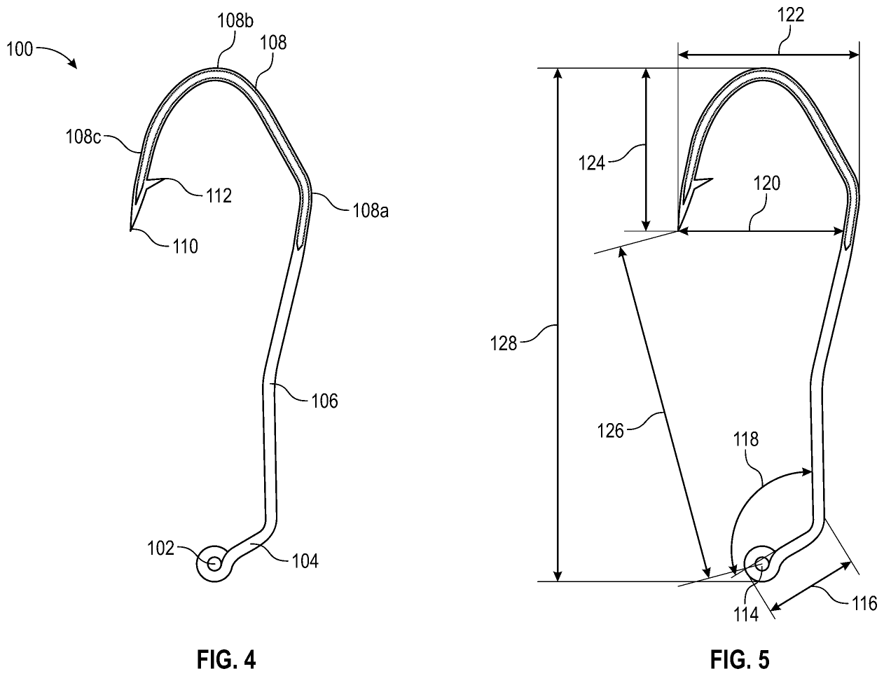

FIG. 4 and FIG. 5 show a fishhook 100, in accordance with another embodiment of the present invention. Fishhook 100 includes an eye 102, an offset section 104, a shank 106, a bend or bend section 108, a hook point or tip 110 and a barb 112.

Bend 108 includes a first segment 108a, a second segment 108b, and a third segment 108c. First segment 108a indicates a point at which bend 108 begins. First segment 108a turns towards the centre of bend 108. Second segment 108b indicates a centre point or bottom of bend 108. Third segment 108c indicates a point at which bend 108 turns inwards. Further, eye 102 has a suitable diameter 114 for receiving fishing line 16. Offset section 104 has a suitable length from eye 102 (offset length 116). In the present embodiment, offset section 104 positions at angle 118 of approximately 120 degrees with respect to shank 106. In other words, offset section 104 is angled at 120 degrees downwards towards shank 106. Hook point 110 and shank 106 position at a distance i.e., gap or gape 120. The distance between the outer surface of shank 106 and hook point 110 is designated as numeral 122. The distance from bend 108 to hook point 110 is a front length 124. The distance from eye 102 and hook point 110 is a leverage 126. The distance from eye 102 to bend 108 is a total length designated as numeral 128.

Fishhook 100 operates similar to fishhook 12, explained above. In the present embodiment, when a jig head (not shown) is used at shank 106, the downward bend of offset section 104 sets the jig head to come through the lips of fish 18 and the bottom of bend (second segment 108b) to push hook point 110 upwards for great hook penetration. In other words, offset section 104 is angled to allow the bait to stay straight and look more natural. Bent/angled portion of offset section 104 opens up the gap between hook point 110 and fishing line 16 for better hook ups. Offset section's 104 downward bend allows the jig head to come through the lips of the fish and the bottom of bend 108 allows pushing hook point 110 upwards for great hook penetration. In one example, fishhook 100 is used with a V-lock swimbait jig head to improve catching of fish 18.

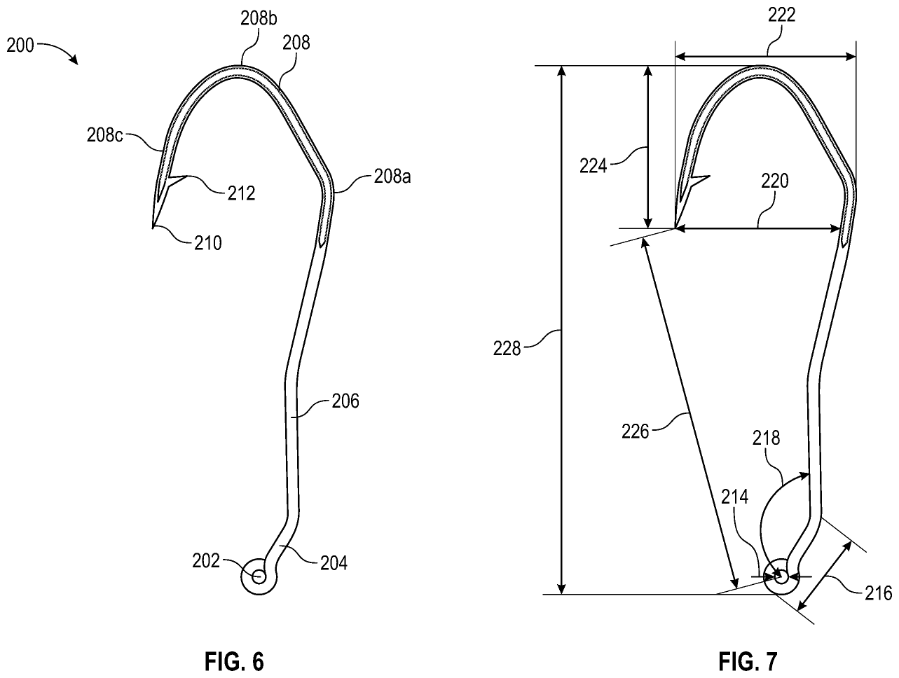

FIG. 6 and FIG. 7 show a fishhook 200, in accordance with yet another embodiment of the present invention. Fishhook 200 includes an eye 202, an offset section 204, a shank 206, a bend or bend section 208, a hook point or tip 210 and a barb 212. Bend 208 includes a first segment 208a, a second segment 208b, and a third segment 208c. First segment 208a indicates a point at which bend 208 begins. First segment 208a turns towards the centre of bend 208. Second segment 208b indicates a centre point of bend 208. Third segment 208c indicates a point at which bend 208 turns inwards. Further, eye 202 has a suitable diameter 214 for receiving fishing line 16. Offset section 204 has a suitable length from eye 202 (offset length 216). In the present embodiment, offset section 204 positions at angle 218 of approximately 150 degrees with respect to shank 206. In other words, offset section 204 is angled at 150 degrees downwards towards shank 206. Hook point 210 and shank 206 position at a distance i.e., gap or gape 220. The distance between the outer surface of shank 206 and hook point 210 is designated as numeral 222. The distance from bend 208 to hook point 210 is a front length 224. The distance from eye 202 and hook point 210 is a leverage 226. The distance from eye 202 to bend 208 is a total length designated as numeral 228.

Fishhook 200 operates similarly to fishhooks 12 and 100 explained above. In the present embodiment, when a jig head (not shown) is used at shank 206, the downward bend of offset section 204 sets the jig head to come through the lips of fish 18 and the bottom of bend (second segment 208b) pushes hook point 210 upwards for great hook penetration. As specified above, offset section 204 is angled to allow the bait to stay straight and look more natural. Bent/angled portion of offset section 204 opens up the gap between hook point 210 and fishing line 16 for better hook ups. Offset section's 204 downward bend allows the jig head to come through the lips of the fish and the bottom of bend 208 allows pushing hook point 210 upwards for great hook penetration.

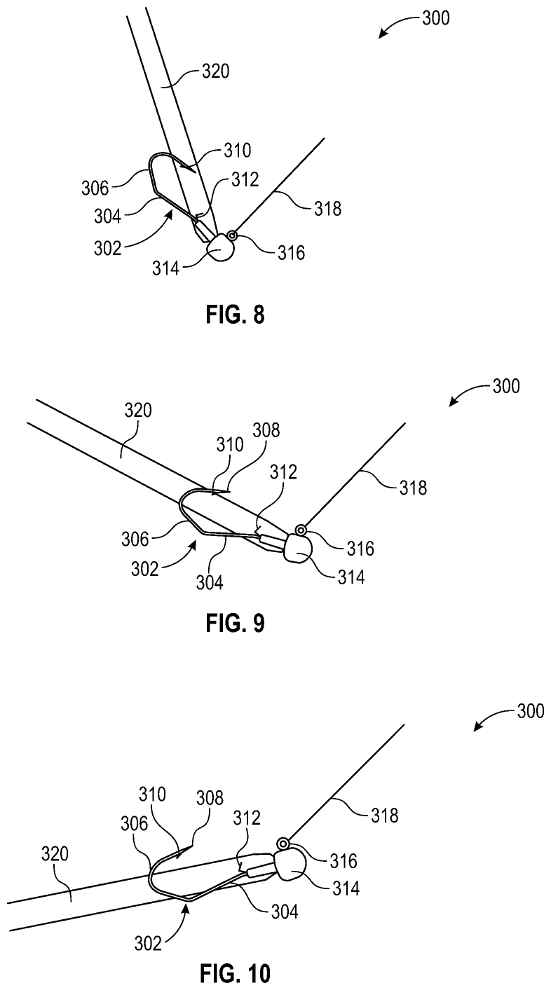

FIG. 8, FIG. 9 and FIG. 10 show various features of a fishhook apparatus 300, in accordance with one embodiment of the present invention. Fishhook apparatus 300 includes a hook 302 having a shank 304. Hook 302 includes a bend 306. Bend 206 is same as bend 28, explained above. Further, hook 302 includes a hook point or tip 308 at the distal end of bend 306. Hook point 308 comes in a variety of shapes including, but not limited to, a needle point, a spear point, rolled in point, a hollow point, a knife edge point, etc. Further, bend 306 includes a barb 310. Barb 310 positions adjacent to hook point 308 facing shank 304. Shank 304 includes a gripping claw 312. Gripping claw 312 positions in proximity to the distal end of shank 304. In one example, gripping claw 312 comes in a L-shaped configuration. Gripping claw 312 aligns with bend 306 such that both gripping claw 312 and bend 306 faces in the same direction.

Further, hook 302 includes a head or jig head 314. Head 314 comes in a variety of shapes and sizes depending on the need. In one example, head 314 comes in asprin, minnow, bugeye bomber, butterbean, shad, octopus, squid, spire or any other shape. Head 314 includes an eye 316. Fishhook apparatus 300 includes a fishing line 318. Fishing line 318 connects to head 314 via eye 316. In other words, eye 316 forms at one side of head 314 and engages fishing line 318. Eye 316 has a suitable diameter for receiving fishing line 318. In addition, fishhook apparatus 300 includes a fishing lure 320. Fishing lure 320 connects to head 314. Fishing lure 320 is made of a suitable material such as soft plastic, for example.

In accordance with one embodiment, fishing lure 320 is configured to bend or position at an angle with respect to fishing line 318 and/or shank 304 to aid in catching a fish 330. FIG. 9 and FIG. 10 show the operational features of fishing lure 320 positioning at an angle with respect to fishing line 318 and/or shank 304, in accordance with one exemplary embodiment of the present invention.

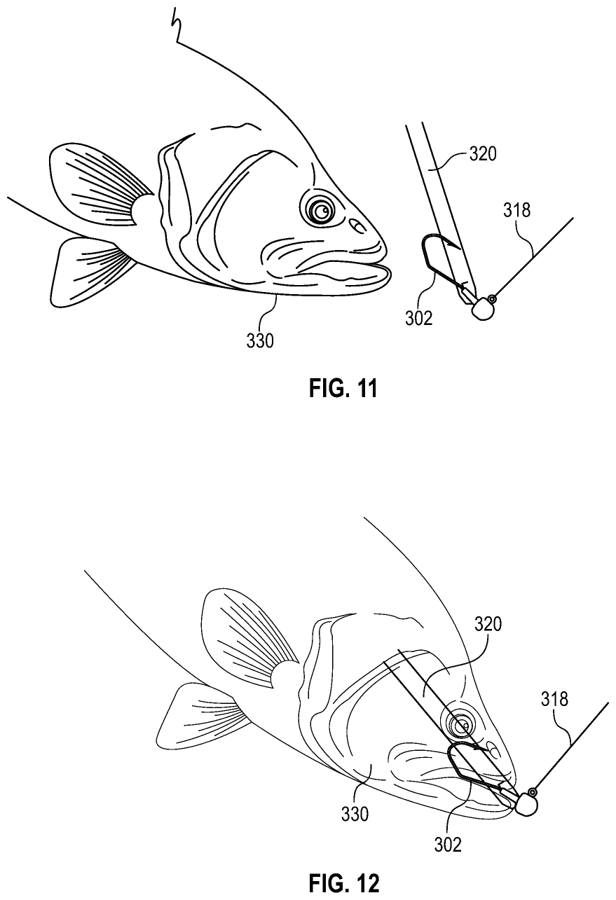

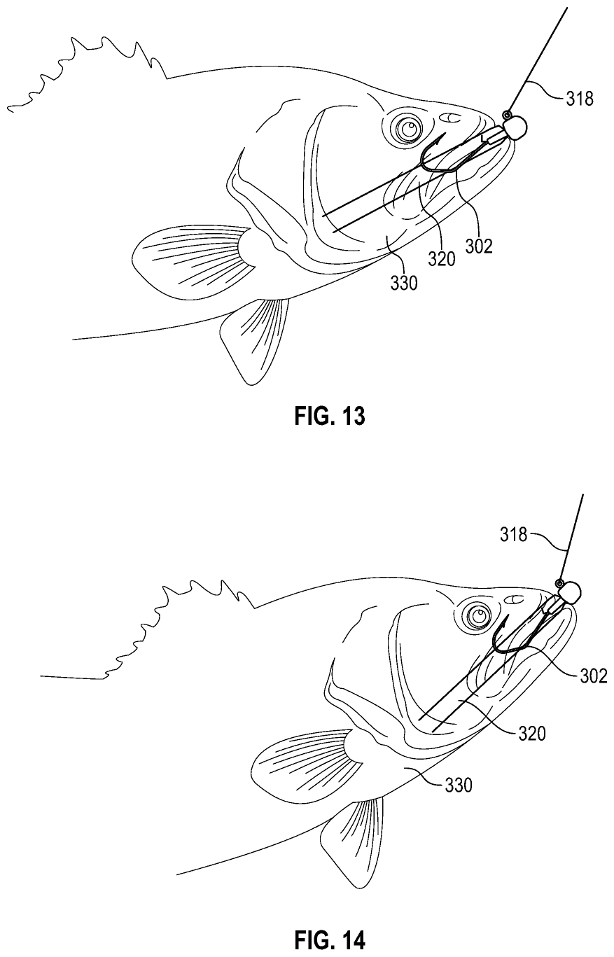

Additionally, FIG. 11, FIG. 12, FIG. 13 and FIG. 14 show fishhook apparatus 300 used for catching a fish 330, in accordance with one exemplary embodiment of the present invention. At first, fishhook apparatus 300 is casted into water by a user (not shown) to lure fish 330 towards fishhook apparatus 300, as shown in FIG. 11. In one scenario, fish 330 approaches fishing lure 320 opening its mouth to catch/eat fishing lure 320, as shown in FIG. 12. Here, hook 302 gets stuck to the mouth of fish 330. Additionally, gripping claw 312 may get stuck to fish 330 and help to hold fish 330 firmly. When fish 330 tries to pull away, the user operating fishing line 318 gets to know fish 330 is stuck to hook 302, and the user tries to pull up fishing line 318, as shown in FIG. 13. Further, the user lifts up fishing line 318 connected to fishhook apparatus 300 holding fish 330, as shown in FIG. 14.

A person skilled in the art appreciates that the fishhook may come in a variety of shapes and sizes depending on the need and comfort of the user. Further, many changes in the design and placement of components may take place without deviating from the scope of the presently disclosed fishhook.

In the above description, numerous specific details are set forth such as examples of some embodiments, specific components, devices, methods, in order to provide a thorough understanding of embodiments of the present invention. It will be apparent to a person of ordinary skill in the art that these specific details need not be employed, and should not be construed to limit the scope of the invention.

In the development of any actual implementation, numerous implementation-specific decisions must be made to achieve the developer's specific goals, such as compliance with system-related and business-related constraints. Such a development effort might be complex and time-consuming, but may nevertheless be a routine undertaking of design, fabrication, and manufacture for those of ordinary skill. Hence as various changes could be made in the above constructions without departing from the scope of the invention, it is intended that all matter contained in the above description or shown in the accompanying drawings shall be interpreted as illustrative and not in a limiting sense.

The foregoing description of embodiments is provided to enable any person skilled in the art to make and use the invention. Various modifications to these embodiments will be readily apparent to those skilled in the art, and the novel principles and invention disclosed herein may be applied to other embodiments without the use of the innovative faculty. It is contemplated that additional embodiments are within the spirit and true scope of the disclosed invention.

What is claimed is:

1. A fishhook, comprising:
a shank;
an offset section connected to said shank, wherein said offset section comprises an eye for receiving a fishing line;
a bend extending from said shank, wherein said bend is angled to have a substantially V-shaped configuration; and
a hook point provided at a distal end of said bend, wherein said hook point points in the direction of said fishing line,
wherein said bend presents a wide gap between said hook point and said shank, wherein said eye aligns with the centre of said bend and provides a leverage gap between said eye and said hook point, wherein a bait is connected to said fishhook such that said offset section allows said bait to stay straight and look natural, wherein said fishhook is casted into water to lure fish to said fishhook, and wherein said hook point pushes up for penetrating said hook point into said fish.

2. The fishhook of claim 1, wherein said bend comprises a first segment, a second segment, and a third segment, wherein said first segment extends from said shank, wherein said second segment positions between said first segment and said third segment, wherein said second segment is angled, wherein said third segment faces downward, and wherein said hook point positions at distal end of said third segment.

3. The fishhook of claim 1, wherein said offset section positions at a right angle with respect to said shank.

4. The fishhook of claim 1, wherein said offset section positions at an angle between 90 to 150 degrees with respect to said shank.

5. The fishhook of claim 1, wherein said eye positions in a head and engages said fishing line.

6. The fishhook of claim 1, wherein said shank comprises a gripping claw, wherein said gripping claw positions in proximity to the distal end of said shank, and wherein said gripping claw gets stuck to said fish and holds said fish firmly.

7. The fishhook of claim 6, wherein said gripping claw aligns with said bend such that both said gripping claw and said bend face in the same direction.

8. The fishhook of claim 6, wherein said gripping claw has a L-shaped configuration.

9. The fishhook of claim 1, wherein said bend comprises a barb positioned adjacent to said hook point and faces said shank.

10. A fishhook, comprising:
a shank;
an offset section connected at an angle to said shank, wherein said offset section comprises an eye for receiving a fishing line;
a bend extending from said shank, wherein said bend comprises a first segment, a second segment, and a third segment, wherein said first segment extends from said shank, wherein said second segment positions between said first segment and said third segment, wherein said second segment is angled, wherein said third segment faces downward, wherein said hook point positions at said third segment, and wherein said first segment, said second segment, and said third segment form a substantially V-shaped configuration; and
a hook point provided at a distal end of said third segment, wherein said hook point points in the direction of said fishing line,
wherein said bend presents a wide gap between said hook point and said shank, wherein said eye aligns with the centre of said bend and provides a leverage gap between said eye and said hook point, wherein a bait is connected to said fishhook such that said offset section allows said bait to stay straight and look natural, wherein said fishhook is casted into water to lure fish into said fishhook, and wherein said hook point pushes up for penetrating said hook point into said fish.

11. The fishhook of claim 10, wherein said bend comprises a barb positioned adjacent to said hook point and faces said shank.

12. The fishhook of claim 10, wherein said offset section positions at a right angle with respect to said shank.

13. The fishhook of claim 10, wherein the angle between said offset section and shank ranges between 90 to 150 degrees.

14. The fishhook of claim 10, wherein said eye positions in a head and engages said fishing line.

15. The fishhook of claim 10, wherein said shank comprises a gripping claw, wherein said gripping claw positions in proximity to the distal end of said shank, and wherein said gripping claw gets stuck to said fish and holds said fish firmly.

16. The fishhook of claim 15, wherein said gripping claw aligns with said bend such that both said gripping claw and said bend face in the same direction.

17. The fishhook of claim 15, wherein said gripping claw has a L-shaped configuration.

18. A method of providing a fishhook, said method comprising the steps of:
providing a shank;
providing an offset section connected to said shank, said offset section comprising an eye for receiving a fishing line;
providing a bend extending from said shank, said bend angled having a substantially V-shaped configuration;
providing a hook point at a distal end of said bend, said hook point pointing in the direction of said fishing line;
connecting a bait to said fishhook such that said offset section allows said bait to stay straight and look natural;
casting said fishhook into water to lure fish to said fishhook; and
pushing up said hook point for penetrating said hook point into said fish.

19. The method of claim 18, further comprising positioning said offset section with respect to said shank at an angle between 90 to 150 degrees.

20. The method of claim 18, further comprising providing a gripping claw in proximity to the distal end of said shank such that both said gripping claw and said bend face in the same direction.
